(19) United States
(12) Patent Application Publication
(10) Pub. No.: US 2008/0192396 A1
(43) Pub. Date: Aug. 14, 2008

(54) OVER-VOLTAGE PROTECTION CIRCUIT AND METHOD THEREOF

(75) Inventors: Xiang-Ping Zhou, Shenzhen (CN); Lin-Kun Ding, Shenzhen (CN); Shih-Fang Wong, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/936,763

(22) Filed: Nov. 7, 2007

(30) Foreign Application Priority Data
Feb. 8, 2007 (CN) 200710200176.1

(51) Int. Cl. H02H 3/20

(52) U.S. Cl. 361/86

(57) ABSTRACT

An over-voltage protection circuit is provided herein for protecting a load from an over-voltage condition, and that does not cause a reverse voltage. The over-voltage protection circuit includes a first switch circuit and a second switch circuit. The first switch circuit is for outputting a switch-on signal when the input voltage is lower than or equal to a predetermined value and a switch-off signal when the input voltage is higher than the predetermined value. The second switch circuit for conducting the input voltage to the load when receiving the switch-on signal. An over-voltage protection method is also provided.

### BACKGROUND

1. Field of the Invention

The present invention relates to over-voltage protection circuits and methods for protecting a load from being damaged by an over-voltage.

2. Description of Related Art

Many digital electronic devices have external batteries and chargers. However, random or transient over-voltage or reverse voltage in the output of the chargers will harm or even permanently damage the electronic devices and the chargers.

Therefore, an over-voltage protection circuit and method is needed in the industry to address the aforementioned deficiencies and inadequacies.

### SUMMARY

An over-voltage protection circuit is for protecting a load from an over-voltage condition and a reverse voltage condition. The over-voltage protection circuit comprises a first switch circuit and a second switch circuit. The first switch circuit is for outputting a switch-on signal when the input voltage is lower than or equal to a predetermined value and a switch-off signal when the input voltage is higher than the predetermined value. The second switch circuit is for conducting the input voltage to the load when receiving the switch-on signal. A related over-voltage protection method is also disclosed.

Other systems, methods, features, and advantages of the present over-voltage protection circuit will become apparent to one with ordinary skill in the art upon examination of the following drawings and detailed description. It is intended that all such additional systems, methods, features, and advantages be included within this description, be within the scope of the present circuit, and be protected by the accompanying claims.

### BRIEF DESCRIPTION OF THE DRAWINGS

Many aspects of the present over-voltage protection circuit can be better understood with reference to the following drawings. The components in the drawings are not necessarily to scale, emphasis instead being placed upon clearly illustrating the principles of the present invention. Further, in the drawings, like reference numerals designate the same parts throughout the several views.

FIG. 1 is a block diagram showing an over-voltage protection circuit in accordance with an exemplary embodiment;

FIG. 2 is a schematic diagram showing a first structure of the over-voltage protection circuit of FIG. 1; and

FIG. 3 is a schematic diagram showing a equivalent circuit of the over-voltage protection circuit of FIG. 2 when the input voltage is lower than or equal to a predetermined value.

FIG. 4 is a schematic diagram showing a equivalent circuit of the over-voltage protection circuit of FIG. 2 when the input voltage is higher than a predetermined value.

FIG. 5 is a flowchart of an exemplary process of the over-voltage protection circuit of FIG. 1.

### DETAILED DESCRIPTION OF THE EMBODIMENTS

Reference will now be made to the drawings to describe a preferred embodiment of the present over-voltage protection circuit.

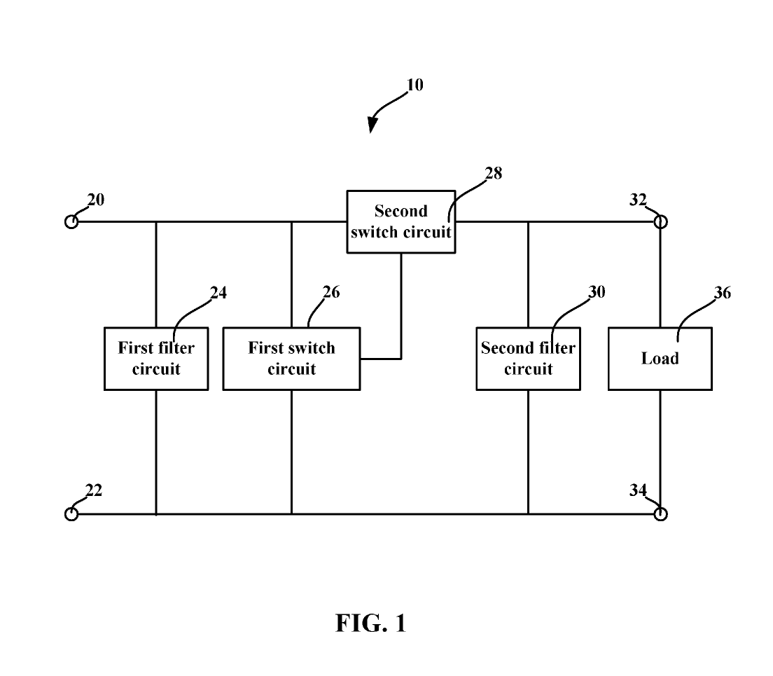

Referring to FIG. 1, an over-voltage protection circuit 10 includes a positive input terminal 20, a negative input terminal 22, a first filter circuit 24, a first switch circuit 26, a second switch circuit 28, a second filter circuit 30, a positive output terminal 32, and a negative output terminal 34.

The first filter circuit 24 is connected between the positive input terminal 20 and the negative input terminal 22. The second switch circuit 28 is connected to the positive input terminal 20, the first switch circuit 26, and the positive output terminal 32. The first switch circuit 26 is connected to the positive input terminal 20, the negative input circuit 22, and the second switch circuit 28. The second filter circuit 30 is connected between the positive output terminal 32 and the negative output terminal 34. The negative output terminal 34 is connected to the negative input terminal 22.

The positive input terminal 20 and the negative input terminal 22 are for receiving an input voltage from a DC power source (a charger or a battery for example, not shown in FIG. 1). The positive output terminal 32 and the negative output terminal 34 are for supplying an output voltage to a load (a digital electronic device for example) 36.

The first filter circuit 24 is for filtering out noise from the input voltage, in order to avoid uncontrolled turn-on actions of the first switch circuit 26.

The first switch circuit 26 is for controlling a switch state of the second switch circuit 28 based on the input voltage received from the positive input terminal 20, by outputting switching signals including a switch-on signal and a switch-off signal. The first switch circuit 26 is turned on and output the switch-off signal when a value of the input voltage is higher than a predetermined value, in other words, when the input voltage becomes an over-voltage. The second switch circuit 28 receives the switch-off signal and is turned off. The first switch circuit 26 is turned off and outputs the switch-on signal to the second switch circuit 28 when the value of the input voltage is lower than or equal to the predetermined value, causing the second switch circuit 28 to be turned on.

The second switch circuit 28 is for transmitting the input voltage from the positive input terminal 20 to the positive output terminal 32 when the second switch circuit 28 is turned on. When the input voltage is transmitted to the positive output terminal 32, there may be a voltage drop at the second switch circuit 28.

The second filter circuit 30 is for filtering out noise from the output voltage of the second switch circuit 28 and the negative input terminal 22. The noise may be produced during a switching action on the second switch circuit 58.

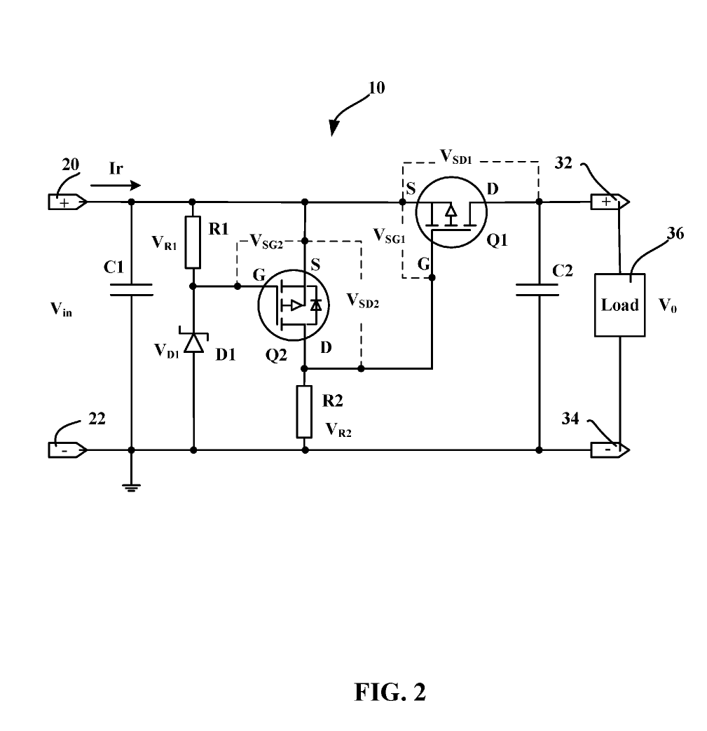

Referring to FIG. 2, is a schematic diagram showing a first structure of the over-voltage protection circuit 10. In this embodiment, the first filter circuit 24 includes a first filter capacitor C1. The second switch circuit 28 includes a first P-Channel enhancement type field effect transistor (FET) Q1. The first switch circuit 26 includes a zener diode D1, a second P-Channel enhancement type FET Q2, a first resistor R1 and a second resistor R2. The second filter circuit 30 includes a second filter capacitor C2. There is a diode integrated between a drain and source of the second FET Q2, such as the FET model NTS4101 P-D.

The first filter capacitor C1 is connected between the positive input terminal 20 and the negative input terminal 22. The second filter capacitor C2 is connected between the positive output terminal 32 and the negative output terminal 34. The source of the first FET Q1 is connected to the positive input terminal 20, the drain of the first FET Q1 is connected to the positive output terminal 32, and the gate of the first FET Q1 is connected to the drain of the second FET Q2. An end of the first resistor R1 is connected to the positive input terminal 20, and another end of the first resistor R1 is connected to a cathode of the zener diode D1. An anode of the zener diode D1 is connected to the negative input terminal 22. The source of the second FET Q2 is connected to the positive input terminal 20, the gate of the second FET Q2 is connected to the cathode of the zener diode D1, and the drain of the second FET Q2 is connected to an end of the second resistor R2. Another end of the second resistor R2 is connected to the negative input terminal 22, which is connected to the negative output terminal 34.

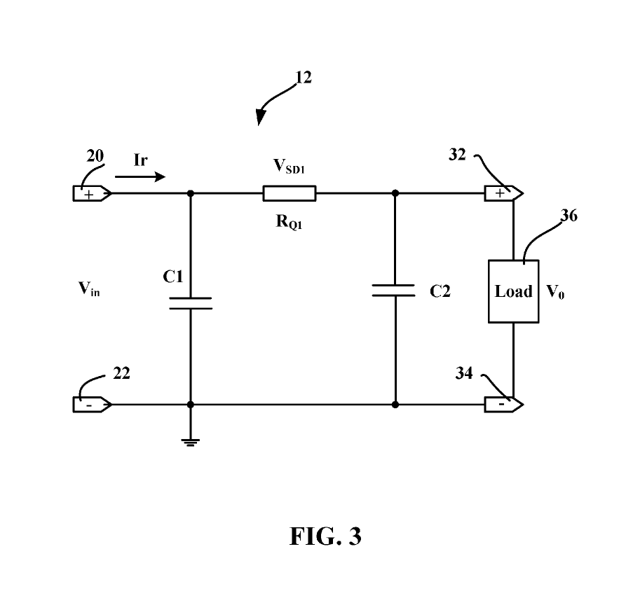

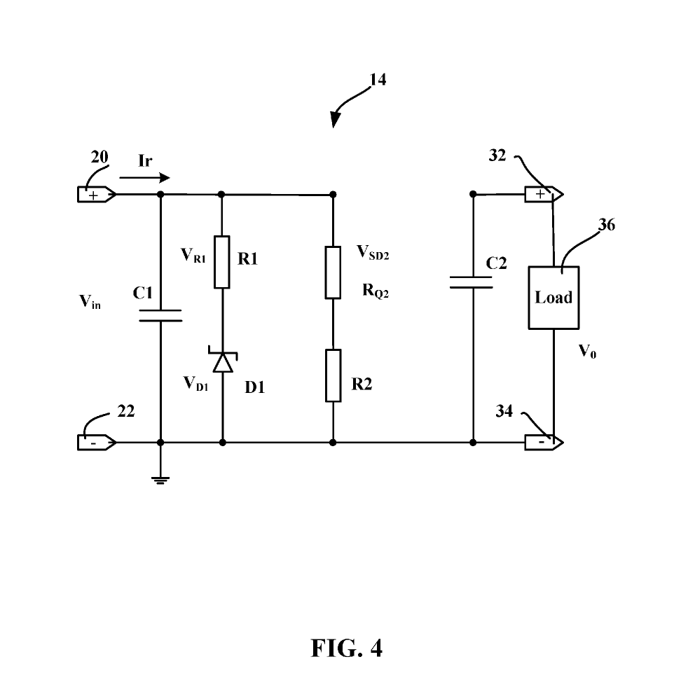

Herein, the input voltage is labeled Vᵢₙ. The voltage difference between the two ends of the first resistor R1 is labeled V_{R1}, which is equal to the voltage difference between the source and gate of the second FET Q2 that is labeled V_{SG2}. The voltage difference between the two ends of the second resistor R2 is labeled V_{R2}. The voltage difference between the cathode and anode of the zener diode D1 is labeled V_{D1}. The voltage difference between the source and drain of the second FET Q2 is labeled V_{SD2}, which is equal to the voltage difference between the source and gate of the first FET Q1 that is labeled V_{SG1}. The voltage difference between the source and drain of the first FET Q1 is labeled V_{SD1}. The output voltage is labeled Vₒ. A rating current of the DC power is labeled Iᵣ. An on-state drain-to-source resistance of the first FET Q1 is labeled R_{Q1} (FIG. 3). An on-state drain-to-source resistance of the second FET Q2 is labeled R_{Q2} (FIG. 4).

Assuming that the DC power source is a charger (not shown in FIG. 2) whose rating current Iᵣ is 500 mA and rating voltage is 5V, which means that the input voltage Vᵢₙ is 5V. The negative input terminal is connected to ground. The breakdown voltage of the zener diode D1 is 5.8V. The first filter capacitor C1 is 1.0 μf. The second capacitance C2 is 0.1 μf. The on-state drain-to-source resistances R_{Q1} and R_{Q2} are all 0.05 ohm. The gate threshold voltages of the first and second FET Q1 and Q2 are all 0.5 V. So when the first FET Q1 is turned on, the voltage difference V_{Sd1} can be calculated according to the following formula (1):

V_{SD1}=Iᵣ×R_{Q1}=500 mA×0.05 ohm=0.025V (1)

According to the above-described assumption, when the input voltage Vᵢₙ is lower than or equal to 5.8V, the zener diode D1 will remain at an off state. The voltage differences V_{R1} and V_{SG2} are 0V, thus the second FET Q2 remains at an off state. The voltage difference V_{R2} is 0V, and the voltage difference V_{SG1} is equal to the input voltage Vᵢₙ, which is higher than the gate threshold voltage (0.5V) of the first FET Q1. As a result, the first FET Q1 turns on to conduct the input voltage Vᵢₙ to the load 36. The output voltage Vₒ can be expressed in the following formula (2):

Vₒ=Vᵢₙ−V_{SD1}=5V−0.025V=4.975V (2)

Referring to FIG. 3, a schematic diagram of an equivalent circuit 12 of the over-voltage protection circuit 10 when the input voltage is lower than or equal to 5.8V is shown.

When the input voltage Vᵢₙ is higher than the breakdown voltage (5.8V) of the zener diode D1, the zener diode D1 experiences a Zener breakdown and is turned on. The voltage difference V_{D1} is held at 5.8V. The voltage difference V_{R1} and V_{SG2} can be expressed in the following formula (3):

V_{R1}=V_{SG2}=Vᵢₙ−V_{D1}=Vᵢₙ−5.8V (3)

Whenever the voltage difference Vᵢₙ is higher than 6.3V (5.8V+0.5V), which means an over-voltage condition occurs, the voltage difference V_{SG2} is higher than the gate threshold voltage (0.5V) of the second FET Q2. The second FET Q2 turns on. Because the on-state drain-to-source resistance R_{Q2} is only 0.05 ohm, the voltage differences V_{SD2} and V_{SG1} will reduce to such a small value (may be 0.025V) that is lower than the gate threshold voltage (0.5V) of the first FET Q1. Thus, the first FET Q1 turns off, and there is no output to the load 36. The load 36 is disabled. Referring to FIG. 4, a schematic diagram of an equivalent circuit 14 of the over-voltage protection circuit 10 when the input voltage is higher than 6.3V is shown.

In addition, the first and second FETs Q1 and Q2 will became turned off when the input voltage is reverse, and the load 36 will not be damaged. If a reverse voltage inputted from the positive output terminal 32 and the negative output terminal 34, the first FET Q1 will became turned off, and the charger will not be damaged.

In the above-described over-voltage protection circuit 10, destruction or damage to the load 36 from over-voltage and reverse-voltage conditions can be prevented by controlling a switch state of the first FET Q1 instantly via the zener diode D1, the second FET Q2, the first resistor R1 and the second resistor R2. The over-voltage protection circuit 10 also has such advantages as low cost and simplicity.

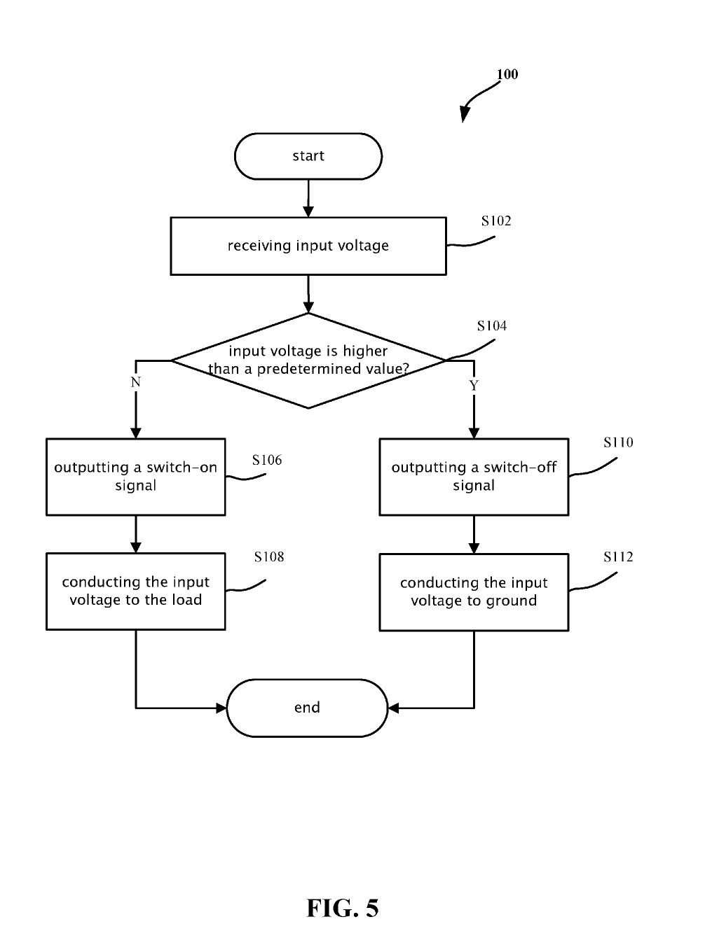

Referring now to FIG. 5, wherein a process flow chart 100 for the over-voltage protection method is shown.

In step S102, the first filter circuit 24, the first switch circuit 26 and the second switch circuit 28 receive an input voltage from a DC power source (not shown in FIG. 1) respectively.

In step S104, the first filter circuit 24 filters out noise in the input voltage, and the first switch circuit 26 judges whether the input voltage is higher than a predetermined value (for example 6.3V).

If the input voltage is lower than or equal to the predetermined value, the first switch circuit 26 is turned off and outputs a switch-on signal to the second switch circuit 28 in step S106. For example, the first switch circuit 26 outputs a voltage that equals to 0V to turn on the second switch circuit 28.

In step S108, the second switch circuit 28 turns on after receiving the switch-on signal and conducts the input voltage to the load 36, and the second filter circuit 30 filters the noise in an output voltage of the second switch circuit 28.

If the input voltage is higher than the predetermined value, the first switch circuit 26 is turned on, and outputs a switch-off signal to the second switch circuit 28 in step S110. For example, the first switch circuit 26 outputs a voltage that nearly equals to the input voltage to turn off the second switch circuit 28.

In step S112, the second switch circuit 28 is turned off when it receives the switch-off signal, and the first switch circuit 26 conducts the input voltage to ground.

It should be emphasized that the above-described preferred embodiment, is merely a possible example of implementation of the principles of the invention, and is merely set forth for a clear understanding of the principles of the invention. Many variations and modifications may be made to the above-described embodiment of the invention without departing substantially from the spirit and principles of the invention. All such modifications and variations are intended to be included herein within the scope of this disclosure and the present invention and be protected by the following claims.

What is claimed is:

1. An over-voltage protection circuit, comprising:
a positive input terminal and a negative input terminal for receiving an input voltage;
a positive output terminal and a negative output terminal for supplying an output voltage to a load;
a first switch circuit connected between the positive input terminal and the negative input terminal, for outputting a switch-on signal when the input voltage is lower than or equal to a predetermined value, and a switch-off signal when the input voltage is higher than the predetermined value; and
a second switch circuit connected between the positive input terminal and the positive output terminal for transmitting the input voltage from the positive input terminal to the positive output terminal when receiving the switch-on signal.

2. The over-voltage protection circuit according to claim 1, wherein the second switch circuit comprises a first field effect transistor comprising a source connected to the positive input terminal, a gate connected to the first switch circuit, and a drain connected to the positive output terminal.

3. The over-voltage protection circuit according to claim 2, wherein the first field effect transistor is a P-Channel enhancement type field effect transistor.

4. The over-voltage protection circuit according to claim 3, wherein the first switch circuit comprises a zener diode, a second field effect transistor, a first resistor and a second resistor; the first resistor is connected between the positive input terminal and the gate of the second field effect transistor, the drain of the second field effect transistor is connected to the gate of the first field effect transistor; the second resistor is connected between the negative input terminal and the drain of the second field effect transistor, the source of the second field effect transistor is connected to the positive input terminal; a cathode of the zener diode is connected to the gate of the second field effect transistor, and an anode of the zener diode is connected to the positive input terminal.

5. The over-voltage protection circuit according to claim 4, wherein the second field effect transistor is a P-Channel enhancement type field effect transistor.

6. The over-voltage protection circuit according to claim 1, wherein the first switch circuit comprises a zener diode, a second field effect transistor, a first resistor and a second resistor; the first resistor is connected between the positive input terminal and the gate of the second field effect transistor, the drain of the second field effect transistor is connected to the gate of the first field effect transistor; the second resistor is connected between the negative input terminal and the drain of the second field effect transistor, the source of the second field effect transistor is connected to the positive input terminal; a cathode of the zener diode is connected to the gate of the second field effect transistor, and an anode of the zener diode is connected to the positive input terminal.

7. The over-voltage protection circuit according to claim 6, wherein the second field effect transistor is a P-Channel enhancement type field effect transistor.

8. An over-voltage protection circuit for conducting an input voltage to a load, and protecting the load when the input voltage becomes an over-voltage, comprising:
a first switch circuit for outputting a switch-on signal when the input voltage is lower than or equal to a predetermined value and for outputting a switch-off signal when the input voltage is higher than the predetermined value; and
a second switch circuit for conducting the input voltage to the load when receiving the switch-on signal.

9. The over-voltage protection circuit according to claim 8, wherein the second switch circuit comprises a first P-Channel enhancement type field effect transistor comprising a drain for receiving the input voltage, a gate for receiving the switch-on signal and the switch-off signal, and a source for outputting the input voltage to the load.

10. The over-voltage protection circuit according to claim 8, wherein the first switch circuit comprises a zener diode, a second field effect transistor, a first resistor and a second resistor; the first resistor is connected between the positive input terminal and the gate of the second field effect transistor, the drain of the second field effect transistor is connected to the gate of the first field effect transistor; the second resistor is connected between the negative input terminal and the drain of the second field effect transistor, the source of the second field effect transistor is connected to the positive input terminal; a cathode of the zener diode is connected to the gate of the second field effect transistor, and an anode of the zener diode is connected to the positive input terminal.

11. The over-voltage protection circuit according to claim 10, wherein the second switch circuit comprises a first P-Channel enhancement type field effect transistor comprising a drain for receiving the input voltage, a gate for receiving the switch-on signal and the switch-off signal from the drain of the second field effect transistor, and a source for outputting the input voltage to the load.

12. The over-voltage protection circuit according to claim 11, wherein the second field effect transistor is a P-Channel enhancement type field effect transistor.

13. An over-voltage protection method for protecting a load when an input voltage becomes an over-voltage, comprising:
receiving the input voltage;
comparing the input voltage with a predetermined value;
conducting the input voltage to the load when the input voltage is lower than or equal to the predetermined value; and
conducting the input voltage to ground when the input voltage is higher than the predetermined value.
